(19) United States
(12) Patent Application Publication
(10) Pub. No.: US 2024/0415329 A1
(43) Pub. Date: Dec. 19, 2024

(54) GRIDDLE COOKING SYSTEM, DEVICE AND METHOD THEREOF

(71) Applicant: North Atlantic Imports, LLC, Logan, UT (US)

(72) Inventors: Christopher L. Hanks, Nibley, UT (US); Steve L. Puertas, Wellsville, UT (US); Ryan D. Tirrell, North Logan, UT (US); James C. Buss, III, Providence, UT (US)

(21) Appl. No.: 18/677,910

(22) Filed: May 30, 2024

Related U.S. Application Data
(60) Provisional application No. 63/469,820, filed on May 30, 2023.

(51) Int. Cl. A47J 37/07

(52) U.S. Cl. CPC A47J 37/0709; A47J 37/0763; A47J 37/0786

(57) ABSTRACT

A cooking system for managing food byproduct, the cooking system including a main body, a griddle, and a drawer. The main body includes structure to support the griddle positioned above a heat element. The griddle includes a cooking surface with an opening defined in the griddle, the opening positioned adjacent a rear end of the cooking surface. The drawer includes a grease container, the drawer being moveable between an inserted position and a removed position. In the inserted position, the grease container is positioned below the opening of the griddle and adjacent a rear side of the main body with a front portion of the drawer accessible along a front side of the main body. With this arrangement, the drawer is removable from the front side of the main body and captures food byproduct in the grease container adjacent the rear side of the main body.

### CROSS-REFERENCE TO RELATED APPLICATIONS

This application claims the benefit of U.S. Provisional Application No. 63/469,820, filed May 30, 2023, the disclosure of which is hereby incorporated by reference herein in its entirety.

### TECHNICAL FIELD

The present invention relates generally to cooking systems and, more specifically, the present invention relates to managing food byproduct with a cooking system.

### BACKGROUND

Barbequing has become a popular and pervasive tradition in much of the world. A barbeque grill is a device for cooking food by applying heat directly below a grill. There are several varieties of grills but most fall into one of two categories, either gas fueled or charcoal. Gas fueled grills typically use propane or natural gas as a fuel source, with the gas flame either cooking the food directly or heating grilling elements which in turn radiate the heat necessary to cook the food. Grilling has become a popular method of cooking food due to the unique flavors and texture imparted to the food during the grilling process.

A griddle is a cooking device consisting of a broad flat surface that can be heated using a variety of means and is used in both residential and commercial applications for a variety of cooking operations. The griddle is most commonly a flat metal plate composed of cast or wrought iron, aluminum or carbon steel. Griddles are commonly heated directly or indirectly by open flame or electrical elements. Using a griddle placed directly on a barbeque grill or over flame burners has also become popular when cooking foods not as well suited for cooking directly on a grill over an open flame.

One concern with griddle cooking is the grease and byproduct build-up that inevitably occurs. Some griddles include a drain system to manage the grease either on the side or front of the griddle. Such locations keep the grease and byproduct in areas relative to the griddle and cooking station that are viewable and in the region where the user is cooking, which is unsightly and still provides the potential for grease to spill and build-up over the front side of the cooking station. Further, this grease build-up will often spread to the user's clothing.

### BRIEF SUMMARY OF THE INVENTION

The present invention is directed to a cooking system configured to manage food byproduct generated from cooking with the cooking system. The cooking system includes a main body, a griddle and a drawer. The main body extends to define a front side, a rear side, a left side, and a right side, the main body including a heating element positioned within an interior thereof. The front side, the rear side, the left side, and the right side extends to an upper periphery and lower periphery of the main body. The griddle is positioned adjacent to the upper periphery such that the griddle extends over the interior of the main body so that the heating element is positioned along an underside of the griddle. The griddle includes a flat cooking surface and a splash guard that extends upward from the flat cooking surface. The flat cooking surface extends to define a front end, a rear end, a left end and a right end such that the front end extends generally parallel with the rear end and the left end extends generally parallel with the right end. The griddle includes an opening defined adjacent the rear end of the griddle or cooking surface. The drawer includes a bottom wall and an upright wall that extends between a front end portion and a rear end portion of the drawer, the drawer configured to hold a removable grease container positioned on the bottom wall of the drawer. The drawer is configured to be removably positioned at least partially within the interior of the main body such that the grease container is positioned adjacent the rear side of the main body and below the opening defined in the griddle with the front end of the drawer positioned along the front side of the main body so that the drawer is moveable from the front side of the main body.

In another embodiment, the grease container is moveable within the drawer between a rear position and a forward position. In a further embodiment, upon the grease container being in the forward position, the grease container is removable from the drawer. In another further embodiment, upon the grease container being in the rear position, the grease container is prevented from being removed from the drawer with a top flange extending inward from the upright wall of the drawer.

In another embodiment, the heating element is an electrical heating element, the electrical heating element extending through an understructure of the griddle. In another embodiment, the main body includes a heat shield, the heat shield extending between the heating element and the drawer, the heat shield configured to shield the grease container from heat of the heating element. In still another embodiment, the main body includes a bottom panel such that the drawer is configured to be moveably positioned above the bottom panel, the drawer including ridges along the bottom wall of the drawer, and the bottom panel including undulations defined therein, the undulations in the bottom panel configured to correspond with the ridges of the drawer to assist in preventing the drawer from being unintentionally removed from the main body.

In another embodiment, the opening is defined at least partially by the splash guard of the griddle. In yet another embodiment, the opening is defined in the cooking surface of the griddle. In another embodiment, the griddle is coupled to a conduit, the conduit extending from the griddle toward the grease container to funnel grease from the opening of the griddle.

In accordance with another embodiment of the present invention, a cooking station configured to manage food byproduct generated from cooking with the cooking station is provided. The cooking station includes a main body, a griddle and a drawer. The main body extends to define a front panel, a rear panel, a left panel, and a right panel. The main body includes an electrical heating element positioned within an interior thereof, the front panel, the rear panel, the left panel, and the right panel extending to an upper periphery and lower periphery of the main body. The griddle is positioned adjacent to the upper periphery such that the griddle extends over the interior of the main body so that the electrical heating element is positioned along an underside of the griddle. The griddle includes a flat cooking surface and a splash guard extending upward from the flat cooking surface, the flat cooking surface extending to define an opening adjacent a rear end of the flat cooking surface of the griddle. The drawer extends between a front end portion and a rear end portion of the drawer, the drawer configured to hold a removable grease container positioned adjacent the rear end portion of the drawer. The drawer is configured to be removably positioned at least partially within the interior of the main body such that the grease container is positioned adjacent the rear panel of the main body and below the opening defined in the griddle. With this arrangement, the front end of the drawer is positioned along the front panel of the main body so that the drawer is moveable from the front panel of the main body.

In another embodiment, the grease container is moveable within the drawer between a rear position and a forward position. In another further embodiment, upon the grease container being in the forward position, the grease container is removable from the drawer. In still another further embodiment, upon the grease container being in the rear position, the grease container is prevented from being removed from the drawer with a top flange extending inward from an upright wall of the drawer.

In another embodiment, the main body includes a heat shield, the heat shield extending between the heating element and the drawer, the heat shield configured to shield the grease container from heat of the heating element. In still another embodiment, the main body includes a bottom panel such that the drawer is configured to be moveably positioned above the bottom panel, the drawer including ridges along the bottom wall of the drawer, and the bottom panel including undulations defined therein, the undulations in the bottom panel configured to correspond with the ridges of the drawer to assist in preventing the drawer from being unintentionally removed from the main body. In another embodiment, the griddle is coupled to a conduit, the conduit extending from the griddle toward the grease container to funnel grease from the opening of the griddle.

In accordance with another embodiment of the present invention, a method for managing food byproduct while cooking on a cooking station is provided. The method includes the step of: providing a main body including a front panel, rear panel, left panel, and right panel extending to define an interior, the main body configured to support a heating element positioned within the interior of the main body, the main body configured to support a griddle positioned adjacent an upper periphery of the main body such that the griddle extends over the interior of the main body, the griddle having a flat cooking surface and the griddle defining an opening therein such that the opening is positioned adjacent a rear periphery of the flat cooking surface of the griddle; pushing the food byproduct to the opening of the griddle such that the food byproduct drains through a conduit to facilitate draining the food byproduct to a grease container of a drawer positioned within the interior of the main body, the drawer extending between a front end and a rear end such that the grease container is removably positionable adjacent the rear end of the drawer; and removing the drawer from the interior of the main body by grasping the front end of the drawer positioned adjacent the front panel of the main body so that the grease container of the drawer slides from adjacent the rear panel of the main body and out of the main body to discard the food byproduct from the grease container.

In another embodiment, the removing step includes sliding the grease container within the drawer between a rear position in the drawer and a forward position within the drawer. In a further embodiment, the sliding step includes removing the grease container from the drawer upon the grease container being in the forward position. In another further embodiment, the sliding step includes preventing removal of the grease container, upon the grease container being in the rear position, due to the drawer having a top flange extending inward from an upright wall of the drawer.

In another embodiment, the method steps further include shielding the grease container in the drawer from heat of the heating element with a heat shield positioned between the heating element and the drawer. In another embodiment, the method steps include heating the griddle with an electrical heating element such that the electrical heating element extends through an understructure of the griddle.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a cooking system (without a hood), depicting the cooking system having a griddle, according to one embodiment of the present invention;

FIG. 2 is a lower perspective view of the cooking system with a hood, according to another embodiment of the present invention;

FIG. 3 is a lower perspective view of the cooking system (with portions of a main body of the cooking system removed), depicting a drawer positioned below a heat shield and the griddle of the cooking system, according to another embodiment of the present invention;

FIG. 4 is a rear perspective view of the cooking system, depicting the drawer positioned partially out of an interior of the cooking system, according to another embodiment of the present invention;

FIG. 5 is a front perspective view of the cooking system, depicting the drawer positioned out of, or removed from, the interior of the cooking system, according to another embodiment of the present invention;

FIG. 5A is a perspective view of the drawer, depicting a grease container positioned in a forward position within the drawer, according to another embodiment of the present invention;

FIG. 5B is a perspective view of the drawer, depicting the grease container removed from the drawer, according to another embodiment of the present invention;

FIG. 6 is a front view of the cooking system, according to another embodiment of the present invention;

FIG. 7 is a bottom view of the cooking system, according to another embodiment of the present invention;

FIG. 8 is a bottom perspective view of an upper half of the cooking system (with components associated with the drawer and lower panels of the main body of the cooking system removed), depicting an understructure and heating element positioned along an underside of the griddle, according to another embodiment of the present invention;

FIG. 9 is a perspective cross-sectional view of the cooking system taken along section line A-A of FIG. 6, according to another embodiment of the present invention;

FIG. 10 is a perspective cross-sectional view of the cooking system similar to FIG. 9, depicting the drawer partially removed from the cooking system, according to another embodiment of the present invention;

FIG. 10A is an enlarged view of the cooking system taken from region C of FIG. 10, according to another embodiment of the present invention;

FIG. 11 is a perspective view of another embodiment of a cooking system (with a hood removed), depicting a griddle with an opening defined partially in a splash guard of the griddle, according to another embodiment of the present invention;

FIG. 12 is a bottom perspective view of a cooking system with a hood, depicting a drawer along a lower side of the cooking system, according to another embodiment of the present invention;

FIG. 13 is a rear perspective view of the cooking system, according to another embodiment of the present invention; and

FIG. 14 is a cross-sectional view of the cooking system taken along section line D-D of FIG. 11, according to another embodiment of the present invention.

### DETAILED DESCRIPTION OF THE INVENTION

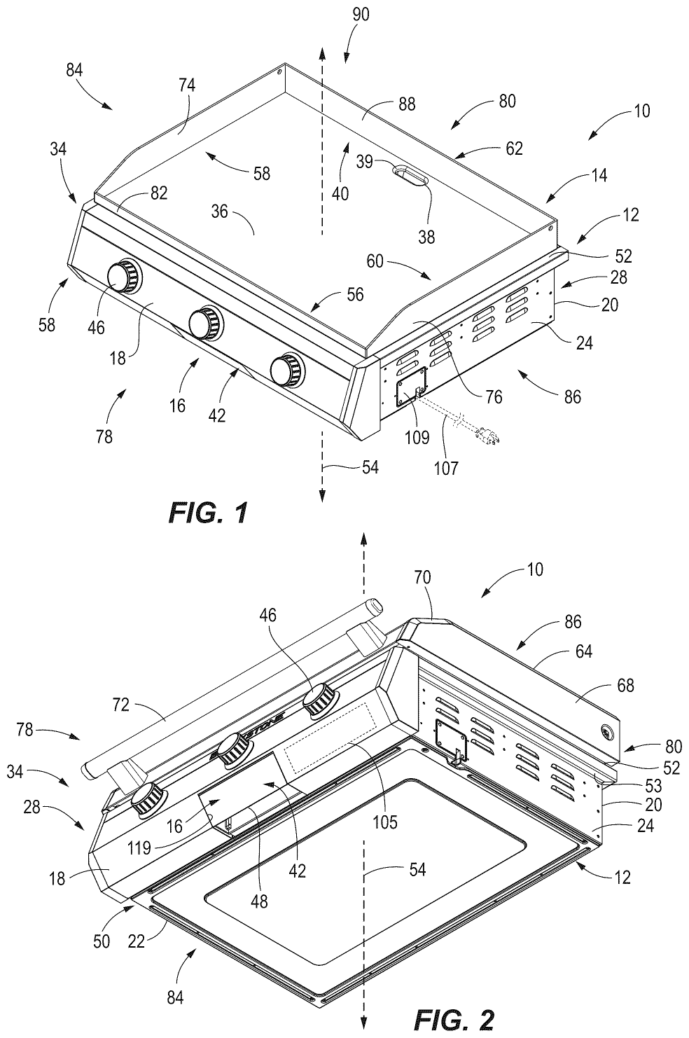

Referring to FIGS. 1, 2, and 9, a cooking system 10 for managing food byproduct, such as grease, generated by the cooking system is provided. Such cooking system 10 may be sized and configured to drain grease adjacent a rear side of the cooking system 10 and sized and configured to access and remove the grease from a front side of the cooking system 10. The cooking system 10 may also be referenced as a cooking device or cooking station. The cooking system 10, as depicted in the drawings, may be employed as an insert-type cooking station such that the cooking device may be intended to remain stationary within a space defined along a counter-top, for example. However, the cooking system 10, set forth herein, is not limited to an insert type cooking station. For example, the cooking system may include other structural components, such as small legs for positioning on a table-top or the like, or such as longer legs with wheels, or a cart or stand with wheels, each of which may facilitate portability of the cooking system 10.

In one embodiment, the cooking system 10 or cooking station may include a main body 12, a griddle 14 supported by the main body 12, and a drawer 16 positioned below the griddle 14. The main body 12 may include various frame components and panels such that the main body may partially extend to define a front panel 18, a rear panel 20, a left panel 22, and a right panel 24. The front, rear, left, and right panels 18, 20, 22, 24 may extend to define an interior 26 and exterior 28 of the main body 12. The main body 12 may be sized and configured to support a heating element 30 within the interior 26 of the main body 12. The griddle 14 may be positioned on an upper periphery 34 or upper side of the main body 12, the upper periphery 34 extending along an upper side of the front, rear, left, and right panels 18, 20, 22, 24. The upper periphery 34 of the main body may extend adjacent to and be positioned to surround the heating element 30 such that the heating element 30 may extend along an underside of the griddle 14. The griddle 14 may include a cooking surface 36 that may define an opening 38 therein positioned adjacent a rear periphery 40 of the cooking surface of the griddle 14. The cooking surface 36 may be referenced as a flat surface or a flat cooking surface. The opening 38 defined in the griddle 14 may be sized and configured to facilitate the funneling or draining of grease to the drawer 16. Such drawer 16 may be positioned below the opening 38 of the griddle 14. Further, the drawer 16 may be positioned within the interior 26 of the main body 12 such that the opening 38 may include structure extending into the interior 26 to direct grease to the drawer 16 and to provide a separation from other components, such as the heating element 30, of the cooking station 10. Further, the drawer 16 may extend to define a front end 42 and a rear end 44. The front end 42 may be positioned along, or adjacent to, the front panel 18. Further, the drawer 16 may be configured to be moveable outwards from the front panel 18 such that the drawer 16 may be removed from the interior 26 of the main body 12. With this arrangement, the cooking system 10 may be configured to manage grease by funneling the grease through the opening 38 adjacent the rear periphery 40 of the griddle 14 and the drawer 16 may catch and maintain the grease therein. The drawer 16 may be removed from a front side of the main body 12, such as from adjacent the front panel 18 of the main body 12 of the cooking system 10 for discarding the grease from the drawer 16.

With reference to FIGS. 1 and 2, as previously set forth, the main body 12 may extend with the front panel 18, the rear panel 20, the left panel 22, and the right panel 24 to define the interior 26 and the exterior 28 of the main body 12. The front panel 18 may include burner knobs 46 sized and configured to activate the heating element 30. In one embodiment, the heating element 30 of the cooking system 10 may be electrically heated and controlled by the burner knobs 46 such that the cooking system 10 and the front panel 18 may include electrical and mechanical components, such as wiring and electrical interconnections, for functionally operating the heating element 30, and any other needed components coupled to, or associated with, the burner knobs 46 and the heating element 30, as known to one of ordinary skill in the art. For example, such burner knobs 46 may each include an integrated digital display. Further, in another embodiment, the front panel 18 may also include a control panel that may include a display and input controls, as known to one of ordinary skill in the art. The burner knobs 46 and the heating element 30 may be associated (interconnected with wiring) with a controller 105, which may include a printed circuit board having one or more processors with programmed software and a memory so as to control various functions associated with the burner knobs 46 and for controlling the heating element 30, as known to one or ordinary skill in the art. The cooking station 10 may be powered with a power cord 107 at least partially positioned behind a side plate 109 along the right panel 24 of the cooking station 10, for example. In another embodiment, the controller 105 and heating elements 30 may be interconnected with one or more sensors (not shown), such as temperature sensors, that may be positioned at various positions along an underside of the griddle 14 that may provide feedback (of actual griddle temperature) and automatic correction to assist in heating the griddle 14 to a desired temperature. In another embodiment, the cooking system 10 may be gas fueled such that the cooking system 10 and the front panel 18 may include various valves, tubing and gas lines for controlling and feeding gas, such as propane or natural gas, to the heating element 30 and controlled via the burner knobs 46 to heat the griddle 14, as known to one of ordinary skill in the art. The front panel 18 may extend at least partially flush with the front end 42 of the drawer 16. The front end 42 of the drawer 16 may exhibit a hand pull 48 or flange such that the drawer 16 may be moveable out of the main body 12. Such drawer 16 may be pulled from the front panel 18, or pulled from below the front panel 18, or both.

The front and rear panels 18, 20 of the main body 12 may be positioned to extend opposite each other and, in some embodiments, may extend parallel to each other. The left and right panels 22, 24 of the main body 12 may be positioned to extend opposite and parallel to each other. Further, each of the front and rear panels 18, 20 may be coupled to the left and right panels 22, 24 at opposite ends thereof such that the front, rear, left, and right panels 18, 20, 22, 24 may extend to define the interior 26 of the main body. The front, rear, left, and right panels 18, 20, 22, 24 may extend to define the upper periphery 34 and a lower periphery 50 of the main body 12. The upper periphery 34 may include a ledge 52 extending perpendicular to, and along or adjacent to one end, of the rear, left, and right panels 20, 22, 24. Further, the ledge 52 may extend along a longitudinal side of the rear, left, and right panels 20, 22, 24. In other embodiments, the ledge 52 may also extend along each of the front, rear, left, and right panels 18, 20, 22, 24. Further, the ledge 52 may define a surface extending inwards toward a center axis 54 of the main body 12. In other embodiments, the ledge 52 may extend outwards or away from the center axis 54 of the main body 12. In some embodiments, the ledge 52 may extend to define an under ledge 53. Such under ledge 53 may be the structure or surface that assists in holding or suspending the cooking station 10 over a counter-top opening defined in a counter-top surface. With this arrangement, the cooking station 10 would be an insert-type cooking station such that the under ledge 53 would directly contact the counter-top surface so that a large part of the main body 12 would sit within the counter-top opening and below the counter-top surface.

The griddle 14 may be positioned to be suspended over the interior 26 of the main body 12 and over the ledge 52 such that the ledge 52 may extend outwards from the main body 12 and parallel to the cooking surface 36 of the griddle 14. In other embodiments, the griddle 14 may be positioned to be supported by and sit on the ledge 52 of the main body 12 such that the griddle 32 may rest slightly above the interior 26 of the main body 12 or over the heating element 30 of the main body 12. The cooking surface 36 of the griddle 14 may extend to a front periphery 56, the rear periphery 40, a left periphery 58, and a right periphery 60. The front periphery 56 may extend generally parallel with the rear periphery 40 of the cooking surface 36 and the left periphery 58 may extend generally parallel with the right periphery 60 of the cooking surface of the griddle 14. As such, the cooking surface may extend with a rectangular or square profile. The front periphery 56 of the cooking surface may be referenced as a front end of the cooking surface 36. The rear periphery 40 may be referenced as a rear end of the cooking surface. Similarly, the left periphery 58 of the cooking surface 36 may be referenced as a left end of the cooking surface 36, and the right periphery 60 of the cooking surface 36 may be referenced as a right end of the cooking surface 36.

The griddle 14 may include a splash guard 62 that may extend upward from a periphery of the cooking surface 36 of the griddle 14. Further, the some or all portions of the splash guard 62 may extend generally perpendicular to the cooking surface 36 of the griddle 14. In one embodiment, the splash guard 62 may extend along each of the front, rear, left, and right periphery 56, 40, 58, 60 of the cooking surface 36 of the griddle 14. The splash guard 62 may be sized and configured to block or minimize splattering of grease from the cooking surface 36 of the griddle 14. Further, the splash guard 62 positioned along the rear, left, and right periphery 40, 58, 60 of the griddle 14 may extend upwards from the cooking surface 36 with a great height than the portion of the splash guard 62 coupled to the front periphery 56. Even further, the splash guard 62 positioned on the left and right periphery 58, 60 may taper downward as the splash guard 62 extends from the rear periphery 40 to the front periphery 56 of the griddle 14.

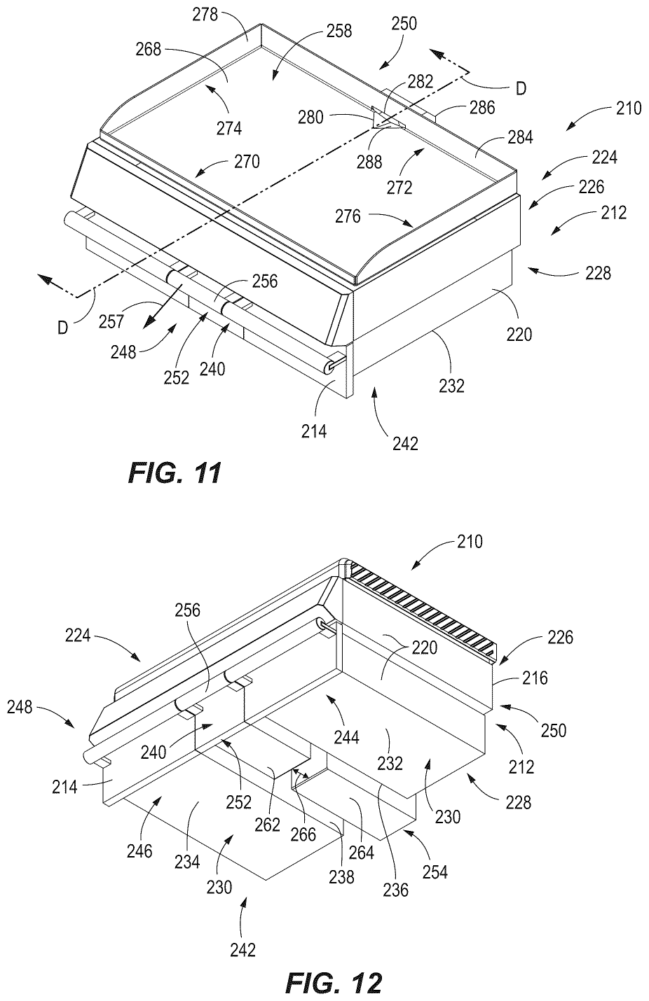

As previously set forth, the griddle 14 includes an opening 38 for draining grease away from the griddle 14. In one embodiment, the cooking surface 36 of the griddle may include a slope positioned adjacent to the opening 38. Such slope 39 may depend directly from the cooking surface to the opening 38. Further, the opening 38 defined in the griddle 14 may be positioned adjacent the rear end or rear periphery 40 of the griddle 14. For example, the opening 38 may be defined adjacent the rear periphery 40 and splash guard 62 so as to be defined in the cooking surface 36. In another embodiment, the opening 38 defined in the griddle 14 may be positioned adjacent the rear periphery 40 of the cooking surface 36 and defined at least partially in the splash guard 62 of the griddle 14 (see, e.g., FIG. 11). Examples of griddles with functionality to manage grease generated from cooking on the griddle are disclosed in commonly assigned U.S. Pat. Nos. 10,327,588 and 10,327,589, the disclosures of which are incorporated by reference herein in their entirety.

Now with reference to FIGS. 1, 2, and 4, the main body 12 may also include a hood 64 or lid that may be pivotably coupled to the cooking system 10 with a pin 92. For example, in one embodiment the hood 64 may be coupled to the griddle 14. In another embodiment, the hood 64 may be coupled to frame structure of the main body 12. In another embodiment, the hood 64 may not be pivotably coupled, but rather, be freely positioned over, and removable from, the griddle 14. The hood 64 may be sized and configured to extend over the griddle 14 such that the cooking surface 36 of the griddle 14, as well as the splash guard 62, may be covered by the hood 64. As such, the hood 64 may be sized and configured to protect the griddle 14 as well as retain heat while cooking. The hood 64 may include a left portion 66 and a right portion 68 coupled to an upper portion 70. The left and right portions 66, 68 may extend generally perpendicular to, or transverse relative to, the upper portion 70 of the hood 64. Further, the upper portion 70 of the hood 64 may include a handle 72 positioned thereon along a front side of the hood 64. Such handle 72 may assist a user in pivotably moving the hood 64 between a closed position (griddle covered position) and an open position (griddle non-covered position) such that the hood may pivot about a pivot axis 91 and about the pin 92. In one embodiment, the hood 64 may be pivotably coupled to the griddle 14 with one or more pins 92 so that the hood may pivot about the pivot axis 91.

In regard to the hood 64 being in a closed position, the left portion 66 and right portion 68 may extend generally parallel to the left and right periphery 58, 60 of the griddle 14. Further, the left portion 66 and right portion 68 may extend generally parallel to a left splash guard 74 and a right splash guard 76 of the griddle 14. Further, in the closed position of the hood 64, the left and right portions 66, 68 of the hood 64 may extend between a front side 78 and a rear side 80 of the main body 12. The upper portion 70 may extend over the cooking surface 36 of the griddle 14 from the rear side 80 to the front side 78 of the main body 12. Further, the upper portion 70 may extend past the front periphery 56 of the griddle 14, or a front splash guard 82, to adjacent the front panel 18 of the main body 12 such that the griddle 14 may be covered by the hood 64 on at least the front side 78, a left side 84, and a right side 86 of the main body 12. In a further embodiment, the upper portion 70 may extend from the rear side 80 of the main body 12, over a rear splash guard 88 of the griddle, and over the front splash guard 82 of the griddle 14 such that the griddle 14 may be covered by the hood 64 on the front side 78, rear side 80, left side 84, and right side 86 of the main body 12.

In regard to the hood 64 being in the open position (not shown), the hood 64 may sit in an upward extending stance and be tipped rearward enough to hold such stance. Further, the left and right portions 66, 68 may be elongated to longitudinally extend away from the left and right periphery 58, 60 of the griddle 14. Further, in the open position of the hood, the underside of the hood 64 or underside of the upper portion 70 of the hood 64 may generally face the user of the cooking station 10, upon the user being positioned along the front side 78 of the main body 12.

As previously set forth, in one embodiment, the hood 64 may be pivotably coupled to the griddle 14 on the left and right splash guards 74, 76. Such pivot may be maintained by one or more pins 92 extending through the left portion 66 of the hood 64 and right portion 68 of the hood 64 and the left splash guard 74 and right splash guard 76 of the griddle 14, respectively. In other embodiments, the hood 64 may be hingeably or pivotably coupled to the main body 12, where the hood 64 may be attached to the rear panel 20 of the main body 12 or also attached to respective rearward sides of the left and right panels 22, 24 of the main body 12. Upon the hood 64 being in the closed position, the handle 72 of the hood 64 may be positioned on the upper portion 70 and along or adjacent the front side 78 of the main body 12. The handle 72, as set forth, may be configured to move the hood 64 between the open and closed positions.

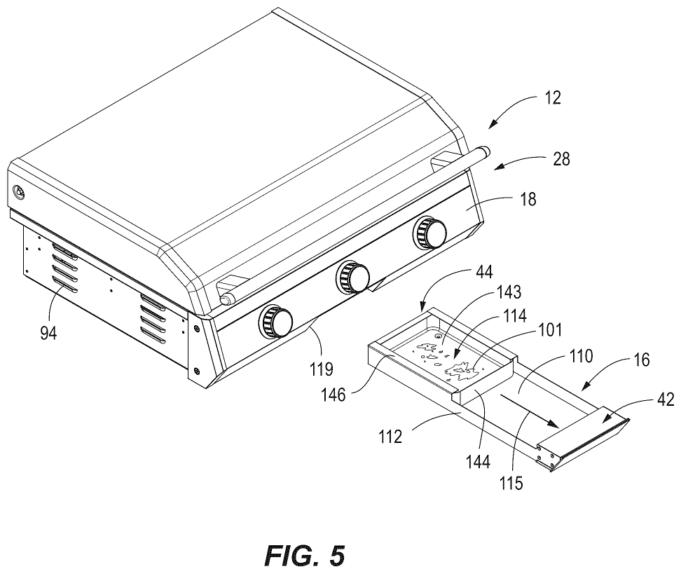

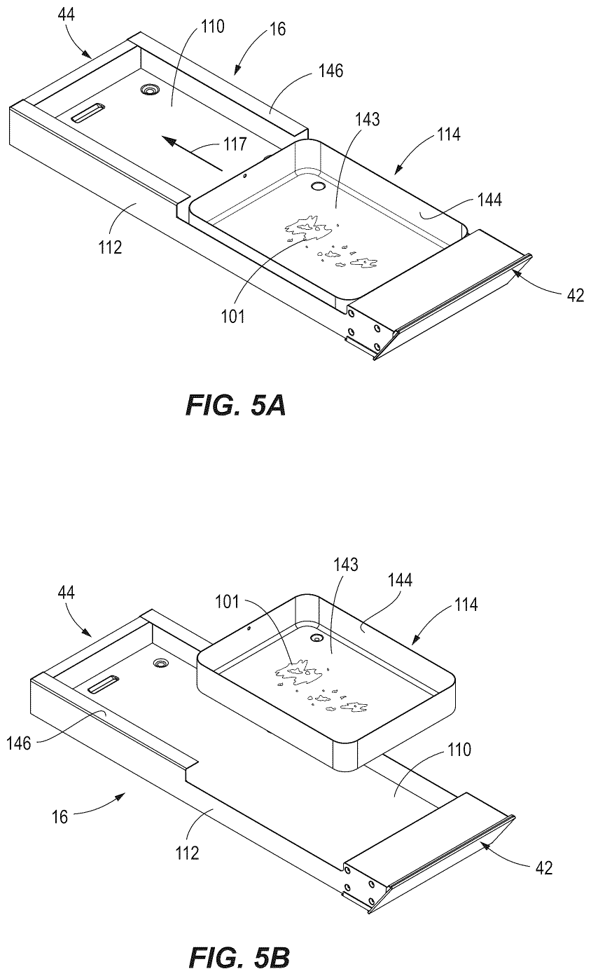

Now with reference to FIGS. 4 and 5, the rear, left, and right panels 20, 22, 24 may include outer vents 94. The outer vents 94 may be positioned in multiples extending laterally and/or longitudinally along the length of the rear, left, and right panels 20, 22, 24 of the main body 12. Further, the outer vents 94 may be sized and configured to provide ventilation relative to the interior 26 of the main body 12. While the outer vents 94 may typically be positioned along the rear, left, and right panels 20, 22, 24, the outer vents 94 may also be positioned on the left and right panels 22, 24, but not along the rear panel 20 or, in other embodiments, the outer vents 94 may be positioned on the rear panel 20 such that ventilation may be implemented solely on the rear side 80 of the main body 12.

With reference to FIGS. 4 and 7, the main body 12 may also extend to include a bottom panel 96 coupled to the front, rear, left, and right panels 18, 20, 22, 24 along or adjacent to the lower periphery 50 of the main body 12. The bottom panel 96 may extend continuously such that the interior 26 (FIG. 9) of the main body 12 may be closed off from a lower side 98 of the main body 12. In a further embodiment, the bottom panel 96 may be positioned above the lower periphery 50 and coupled to the front, rear, left, and right panels 18, 20, 22, 24 of the main body 12. In either embodiment, the drawer 16 may be positioned above the bottom panel 96.

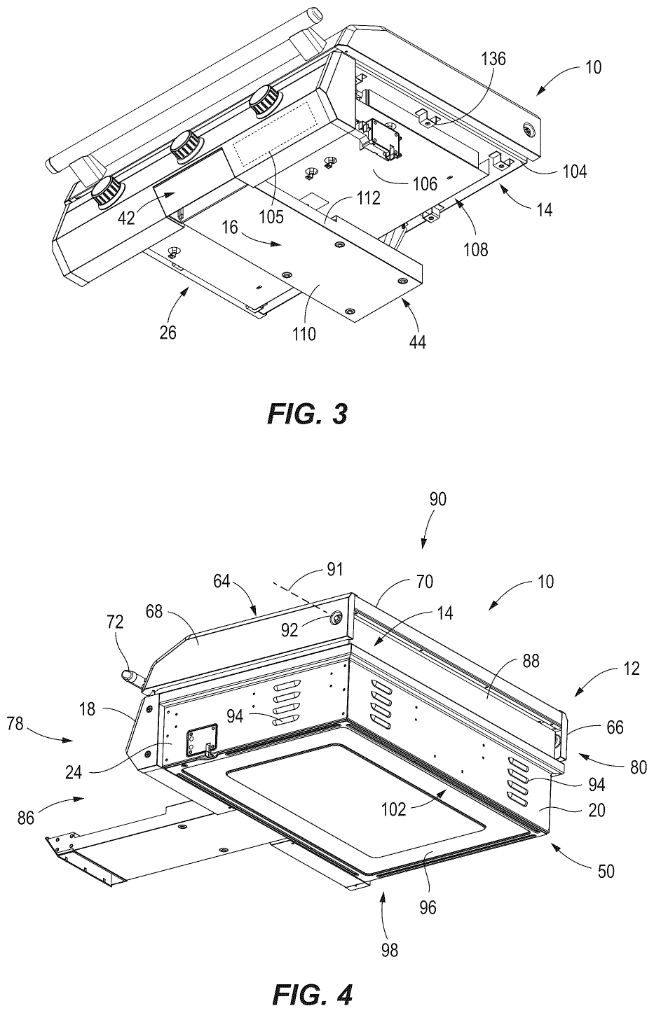

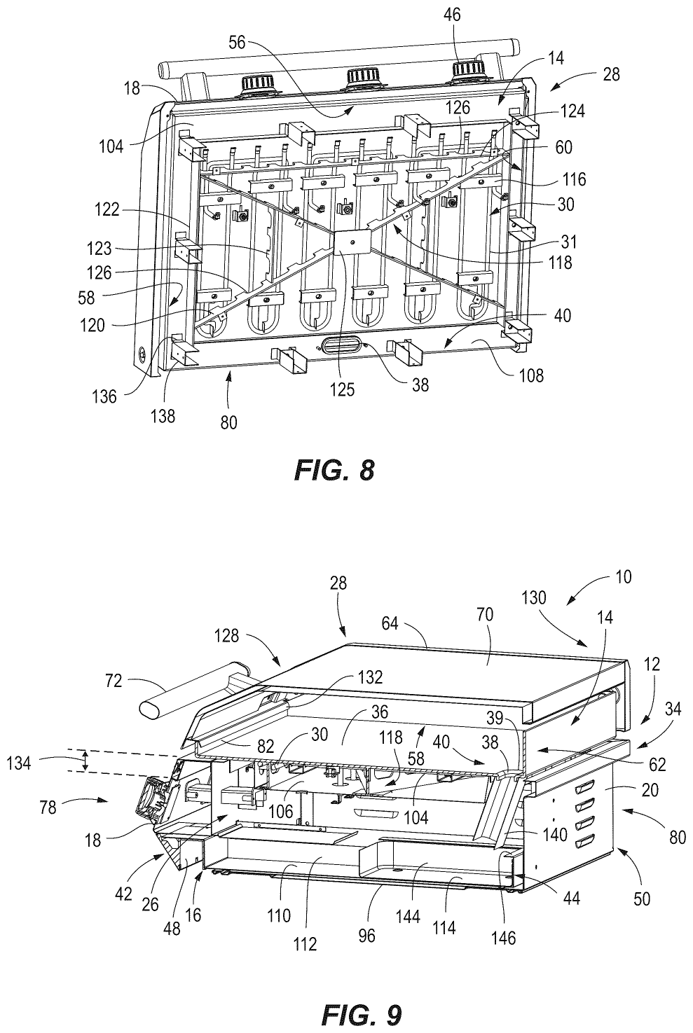

Now with reference to FIG. 3, as previously provided, the cooking system 10 may be configured as an electrical cooking system or a gas fueled cooking system. In regard to an electrically heated cooking system, the heating element 30 (FIG. 8) may be positioned and secured to a lower surface 104 or directly adjacent to an underside surface of the griddle 14. The interior 26 may also include a heat shield 106 positioned to extend below the heating element 30 (FIG. 8). The heat shield may also be referenced as a burner panel, or shield panel, or the like. Such heat shield 106 may be sized and configured to shield the drawer 16 from heat of the heating element 30. Further, the heat shield 106 may also act as a reflector to reflect or deflect heat toward the griddle 14. The heat shield 106 may be coupled to the front panel 18 of the main body 12 and extend parallel to a lower surface 104 of the griddle 14. In one embodiment, the heat shield 106 may extend from the front panel 18 to the rear panel 20 such that the heat shield 106 may completely divide the interior 26 of the main body 12. In another embodiment, the heat shield 106 may extend from the front panel 18, parallel to a substantial portion of the lower surface 104 of the griddle 14. The heat shield 106 may be secured to the lower surface 104 of the griddle 14 so as to define an outer peripheral portion 108 of the griddle such that the heat shield 106 may extend to substantially divide the interior 26 of the main body 12. Further, the heat shield 106 may be designed and configured to retain warmed air near the lower surface 104 of the griddle 14 so as to shield heat away from the drawer 16. In another embodiment, the heat shield 106 may act as a grease shield for safety purposes, separating the drawer 16 from the heating element 30 to, thereby, assist in preventing grease from the drawer 16 coming in contact with the heating element 30.

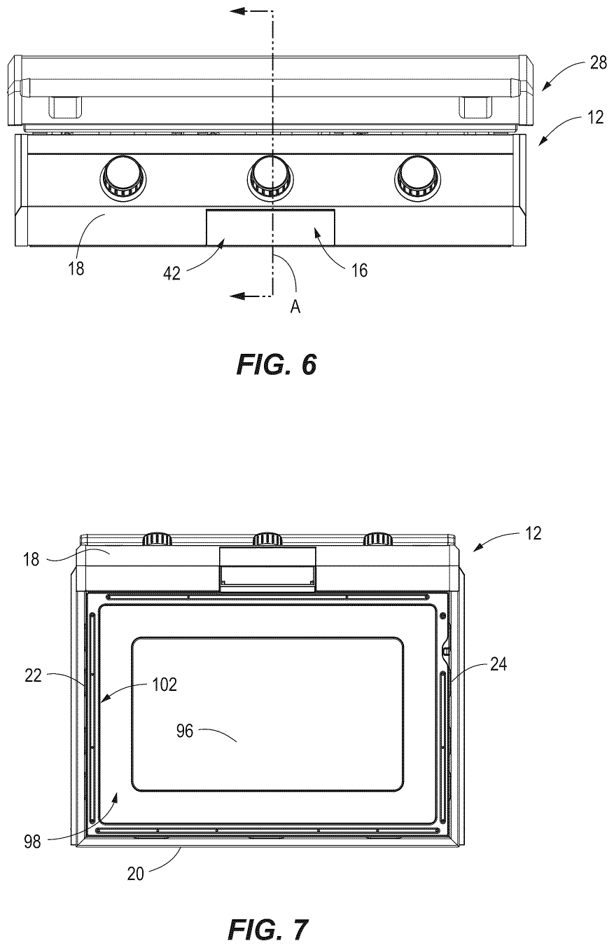

With reference to FIGS. 3, 5, and 6, the drawer 16 may extend to define the front end 42 and the rear end 44 as opposing ends of the drawer 16. Such drawer 16 may also be referenced as a tray, a receptacle, or the like. Upon the drawer 16 being positioned in an engaged, fully inserted use position, the front end 42 of the drawer 16 may be positioned along or adjacent the front panel 18 and the rear end 44 of the drawer may be positioned along or adjacent the rear panel 20 of the main body 12. Further, the front end 42 of the drawer 16 may be positioned to extend as part of the exterior 28 of the main body 12 while the rear end 44 may be positioned against or adjacent the rear panel 20 within the interior 26 of the main body 12. The drawer 16 may define a bottom wall 110 and upright walls 112 extending between the first and second ends 42, 44 of the drawer 16 such that a top side of the drawer 16 may be open. The drawer 16 may be oriented within the main body 12 such that the bottom wall 110 may extend substantially parallel to the heat shield 106 and the cooking surface 36 of the griddle 14 and the upright walls 112 may extend upwards from the bottom wall 110 of the drawer 16 towards the heat shield 106. In one embodiment, the bottom wall 110 and the upright walls 112 of the drawer 16 may be sized and configured to retain grease and other food debris. Such drawer 16 may be sized and configured to hold a removable grease container 114 therewith, the grease container 114 being a separate component from the drawer 16.

With reference to FIGS. 5, 5A and 5B, the grease container 114 may extend with a base bottom wall 143 and side walls 144. The grease container 114 may be sized and configured to be positioned within the drawer 16 such that the grease container 114 may be slidably movable along a longitudinal length of the bottom wall 110 between the upright walls 112 of the drawer 16, as depicted by arrow 115 (FIG. 5) and as depicted by arrow 117 (FIG. 5A). As such, the grease container 114 may be moved within the drawer 16 between a rear position (FIG. 5) and a forward position (FIG. 5A). With the grease container 114 in the rear position, the upright walls 112 of the drawer 16 may extend so that a top flange 146 extends over the side walls 144 of the grease container 114. Such top flange 146 may also be in the form of one or more tabs, or the like, that may be minimized in size relative to the top flange 146 depicted herein. Such top flange 146 may substantially prevent the grease container 114 from being removed from the drawer 16 when the grease container 114 is in the rear position. Further, the top flange 146 may assist in containing food byproduct 101 within the grease container 110 by minimizing and containing potential splashes or splatters of, for example, grease. Upon moving the grease container 114 to the forward position as shown in FIG. 5A, the grease container 114 may be removed from being under the top flange 146 of the drawer 16. At this forward position, if desired, the grease container 114 may be readily removed from the drawer 16, as shown in FIG. 5B. Upon removing the grease container 114 from the drawer 16, grease or food byproduct 101 collected in the grease container may be discarded and, if desired, the drawer 16 and/or the grease container 114 can be cleaned. The grease container 114 may then be placed in the forward position in the drawer 16, the user may then move the grease container 114 from the forward position to the rear position so that the grease container 114 is under the top flange of the drawer 16. The drawer 16 and the grease container 114 may then be inserted into a drawer opening 119 defined in the front panel 18 of the main body 12 and moved rearward so the drawer is fully inserted into the cooking station 10 (see FIGS. 2, 5 and 9).

Now with reference to FIG. 8, as previously set forth, the heating element 30 may be electrically heated. As such, the heating element 30 may include one or more electrical heating elements 31. The one or more electrical heating elements 31 of the heating element 30 may be secured adjacent to and along the lower surface 104 of the griddle 14. In one embodiment, the heating element 30 may include three electrical heating elements configured to be separately and independently activated by corresponding ones of the burner knobs 46. The one or more electrical heating elements 31 may be secured to the lower surface 104 of the griddle 14 with securements 116 positioned along the lower surface 104 to hold portions of the one or more electrical heating elements 31. As such, the one or more electrical heating elements 31 may extend over and along the lower surface 104 of the griddle 14 such that the securements 116 may be configured to hold the one or more electrical heating elements 31 adjacent to the lower surface 104 of the griddle 14. The one or more electrical heating elements 31 may be a tubular type electrical heating element system that may be specified for 240 Volts, for example, or any other suitable electrical heating element system, as known by one of ordinary skill in the art. Further, such one or more electrical heating elements 31 may be interconnected to corresponding ones of the burner knobs 46 and the controller 105 with electrical wires and powered by the power cord 107 (see FIGS. 1 and 2), as known to one of ordinary skill in the art.

The lower surface 104 of the griddle 14 may also include an understructure 118 coupled thereto. Such understructure 118 may be sized and configured to extend to be positioned for minimizing a potential of the griddle 14 becoming warped as the griddle undergoes the effects of thermal stress. For example, the understructure 118 may extend to include diagonal structures 120, side structures 122, and a front structure 124. In some embodiments, the understructure 118 may include inner side structures 123. Further, in some embodiments, the understructure 118 may include one or more rear structures. The diagonal structures 120 may extend from opposing ends (or adjacent thereto) of the left periphery 58 of the griddle 14 so as to extend diagonally to opposing ends (or adjacent thereto) of the right periphery 60 on the lower surface 104 of the griddle 14. As such, the diagonal structures 120 may extend to exhibit an x-configuration along the underside or lower surface 104 of the griddle 14. In some embodiments, ends of the diagonal structures 120 may be coupled to the side structures 122. The diagonal structures may include a central plate 125 positioned and secured to the intersection of the x-configuration defined by the diagonal structures 120. Such central plate 125 reinforces the stabilization of diagonal structures 120 and the x-configuration along the underside surface of the griddle 14 and, thus, reinforces and minimizes the effects of thermal stress on the griddle 14. The side structures 122 may substantially extend the length of the left and right periphery 58, 60 and may be coupled to the diagonal structures 120. Further, the inner side structures 123 may be positioned between the diagonal structures along the lower surface 104 to further brace the diagonal structures 120 and the griddle 14. The front structure 124 may extend along the front periphery 56 of the griddle 14 and may also be coupled to the diagonal structures 120 such that the front structure 124 may extend perpendicular to the side structures 122 and the inner side structures 123. The various components of the understructure 118, such as diagonal structures 120, side structures 122, inner side structures 123 and front structure 124 may be sized and configured to maintain the structural integrity of the griddle 14 as the griddle 14 undergoes the effects of thermal stress and thermal strain. Of the various components of the understructure 118, the diagonal structures 120 that form the x-configuration over the underside of the griddle 14 may be the most critical in maintaining the structural integrity of the griddle. The central plate 125 may also be critical to maintain the structural integrity of the griddle 14 since the central plate 125 reinforces and holds the diagonal structures 120 in their respective positions to maintain the x-configuration. The components of the understructure 118 including the central plate 125 may be coupled to the underside of the griddle 14 and/or to each other via welding, as known to one of ordinary skill in the art.

Further, the understructure 118 may include openings 126 or vents defined therein. In some embodiments, the openings 126 defined in the diagonal structures 120 and the inner side structures 123 may be sized and configured to allow for air flow to move substantially freely along the lower surface 104 of the griddle 14. In another embodiment, the openings 126 may also be defined in the front structure 124 to facilitate air flow. In another embodiment, the openings 126 defined in the diagonal structures 120 and the front structure 124 may facilitate the one or more electrical heating elements 31 to extend along the underside of the griddle 14 and through the openings 126 defined in the diagonal structures 120 and the front structure 124. As such, the understructure 118 may be sized and configured with the openings 126 defined therein to accommodate the positioning of the electrical heating elements 31 through the understructure 118. Similar understructure coupled to a griddle is disclosed in commonly assigned U.S. patent application Ser. No. 17/725,630, filed on Apr. 21, 2022, entitled “COOKING STATION AND GRIDDLE WITH UNDERSTRUCTURE AND METHOD THEREOF,” the disclosure of which is incorporated herein in its entirety.

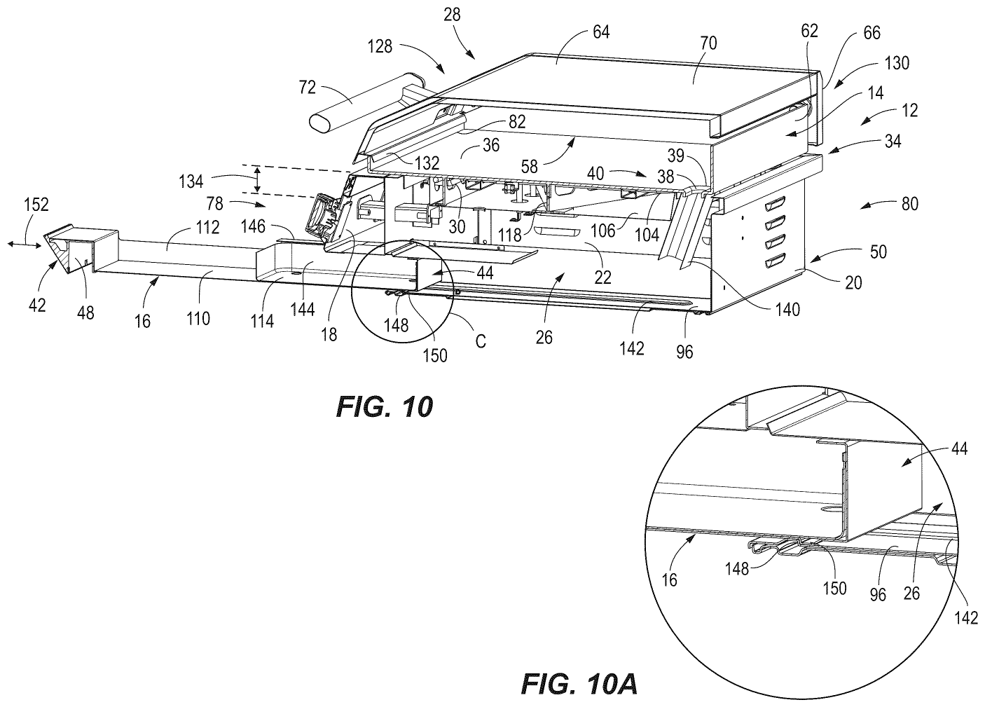

Now with reference to FIGS. 9 and 10, the hood 64 being in the closed position, may extend from the front side 78 of the main body 12 over the griddle 14 to the rear side 80 of the main body 12. Further, the hood 64 may be configured to extend in a similar manner to that of the splash guard 62 of the griddle 14. For example, the left and right portions 66, 68 (FIG. 2) of the hood 64 may taper as they extend from the rear side 80 of the main body 12 to the front side 78 of the main body 12 similar to the splash guard 62 extending along the left and right periphery 58, 60 (FIG. 1) of the griddle 14. The hood 64 may also include a first end 128 and a second end 130 defined on the upper portion 70 of the hood 64, with the first end 128 positioned on the front side 78 of the main body 12 and the second end 130 positioned on the rear side 80 of the main body 12. Further, the first end 128 may include the handle 72 positioned thereon. Even further, the first end 128 may extend to define a rest 132 or inward flange. The rest 132 coupled to an inside of the hood 64, partially above the first end 128 such that the rest 132 may extend inwards towards the griddle 14. Further, the rest 132 may be sized and configured to be positioned on the front splash guard 82 of the griddle 14 such that the rest 132 may suspend the hood 64 slightly above the front panel 18 of the main body 12.

Now with reference to FIGS. 3, 8, 9, and 10, the lower surface 104 of the griddle 14 may include the outer peripheral portion 108 defined by the understructure 118 and the heat shield 106 (see also FIG. 3). The heat shield 106 may extend over a portion of the lower surface 104, and may extend over the entirety of the heating element 30 and the understructure 118. The heat shield 106 may extend from the front panel 18 to the outer peripheral portion 108 and may extend substantially parallel to the lower surface 104 of the griddle 14 such that a depth 134 may be defined between the heat shield 106 and the lower surface 104 of the griddle 14. The outer peripheral portion 108 of the griddle may include feet 136 (see FIG. 3) sized and configured to be positioned (and secured) on brackets 138 directly coupled to the front, rear, left, and right panels 18, 20, 22, 24 (FIG. 2) of the main body 12 such that the brackets 138 may be positioned within the interior 26 of the main body 12. The brackets 138 may be positioned adjacent the upper periphery 34 of the front, rear, left, and right panels 18, 20, 22, 24 (FIG. 2) of the interior 26 of the main body 12 and may extend towards the lower periphery 50 of the main body 12. Further, the brackets 138 may be sized and configured to hold the weight of the griddle 14 with the feet 136 of the griddle 14 positioned thereon, the brackets 138 secured to the feet 136 with fasteners. As such, the fect 136 of the griddle 14 may be secured to the main body 12 via the brackets 138. With this arrangement, the griddle 14 may maintain its position with the main body 12 so that the electrical heating elements 31 extending along the underside of the griddle 14 and through the understructure 118 may also hold a secure position, which in turn minimizes the potential of wiring and connections (not shown) between the electrical heating elements 31 and the burner knobs 46, as well as the controller 105, of becoming bumped or disconnected.

As previously provided, the opening 38 defined in the griddle 14 may be positioned along or adjacent to the length of the rear periphery 40 of the griddle 14. In some embodiments, the opening 38 may be defined in the splash guard 62 of the griddle 14. Further, the opening 38 may extend from the cooking surface 36 to the lower surface 104 of the griddle 14, such that the opening 38 may extend from the exterior 28 of the main body 12 to the interior 26 of the main body 12. The opening 38 may include the before discussed slope 39 extending to or from the opening 38. Further, the opening may be associated with a conduit 140. In one embodiment, the conduit 140 may extend directly from structure defining the opening 38. In another embodiment, structure may extend from the opening 38 that may extend into the conduit 140. In another embodiment, the conduit 140 may be coupled to the lower surface 104 of the griddle 14. Further, the conduit 140 may extend from the lower surface 104 of the griddle 14 to the drawer 16 positioned at least partially below the conduit 140. The conduit 140 may be positioned on the outer peripheral portion 108 of the lower surface 104 of the griddle 14. Further, the conduit 140 may extend to the grease container portion 114 positioned and coupled to a rear end 44 of the drawer 16. Further, the conduit 140 may be enclosed to direct grease and food debris to the drawer 16 such that splatter throughout the interior 26 of the main body 12 may be minimized or absent. Even further, the conduit 140 may extend from the opening 38 at an angle which may assist in spreading grease and food debris into the drawer 16, and more specifically, into the grease container 114 of the drawer 16. The angle of the conduit 140 may allow for the grease and food debris to readily move downward to drain into the grease container 114 of the drawer 16.

Now with reference to FIGS. 5, 9 and 10, the interior 26 of the main body 12 may include the drawer 16 positioned therein, the drawer 16 extending between the front panel 18 and the rear panel 20, upon the drawer 16 being in a fully inserted position within the cooking station 10. Further, the drawer 16 may be elongated to longitudinally extend parallel to the left and right panels 22, 24 of the main body 12. As previously set forth, the drawer 16 may include the bottom wall 110 and upright walls 112 such that the upright walls 112 may extend generally perpendicular to the bottom wall 110. The bottom wall 110 may be positioned directly adjacent to the bottom panel 96 so that the bottom wall 110 of the drawer 16 may be positioned over the bottom panel 96. The drawer 16 may extend with the front end 42 and rear end 44 positioned along the front panel 18 and rear panel 20, respectively. Further, the drawer 16 may be moveable such that the hand pull 48 positioned on the front end 42 of the drawer 16 may allow for a user to grip or grasp the hand pull 48 and move the drawer 16 from the interior 26 of the main body 12. The interior 26 may extend to include guides 142 configured to guide the drawer 16 into position within the interior 26 of the main body 12 and to keep the drawer 16 from going off path while moving within the interior 26 of the main body 12. The guides 142 may extend between the front panel 18 and the rear panel 20 and may be sized for the drawer 16 to extend and move therealong.

The drawer 16 may be configured to be moveable within the interior 26 of the main body 12 such that the drawer 16 may be removable from the main body 12. The drawer 16 may be moved between a fully inserted position or first position (FIG. 9) and a fully removed position or second position (FIG. 5). The fully inserted position may be a use position of the drawer 16 so that the grease container 114 sits under the conduit 140 (as depicted in FIGS. 2 and 9). The drawer 16 may be moved to the fully removed position or second position (see FIG. 5) to discard the food byproduct 101 collected in the grease container 114 of the drawer 16, after which, the drawer 16 may be cleaned or simply re-inserted into the main body 12 to the fully inserted position. As a user moves the drawer 16 between the first and second positions, as shown by bi-directional arrow 152. The direction of bi-directional arrow 152 and, thus, the movement of the drawer 16 may extend substantially parallel to the cooking surface 36 of the griddle 14 or perpendicular relative to the center axis 54 (FIG. 1) of the main body 12. Further, in the first position of the drawer 16, the drawer 16 may include the grease container 114 therewith such that the grease container 114 may be positioned adjacent to the rear end 44 of the drawer 16 so as to be positioned below the opening 38 and the conduit 140. Further, as previously set forth, the grease container 114 is moveable within the drawer 16 and removable from the drawer 16. As such, upon the drawer being placed in the fully inserted position, it is important for the grease container 114 to be positioned in the rear position within the drawer 16 such that the grease container 114 may be positioned so that the top flange 146 of the drawer 16 extends over the side walls 144 of the grease container 114. In this manner, the drawer 16 and/or the grease container 114 may be sized and configured to hold and contain grease and food byproduct 101 that may be funneled through the opening 38 of the griddle 14 and through the conduit 140, and then readily removed from the cooking station 10 to discard the collected food byproduct 101 (see FIGS. 5, 5A and 5B).

Now with reference to FIGS. 10 and 10A, the drawer 16 may be removed from the interior 26 of the main body 12 by pulling the drawer 16 from the front panel 18 of the main body 12. The guides 142 may be positioned on the bottom panel 96 and may extend parallel to the front end 42 and the rear end 44 of the drawer 16. The bottom panel 96 may also include an undulation 148 positioned therein near the front side 78 or front panel 18 of the main body 12. The undulation 148 may extend upwards from the bottom panel 96 and may be sized and configured to provide interference or friction between the drawer 16 and the bottom panel 96. Further, the drawer 16 may include ridges 150 defined on the bottom of the drawer 16. The ridges 150 may extend down towards the bottom panel 96 of the main body 12. The ridges 150 may be sized and configured to cooperate or correspond with the undulation 148 of the bottom panel 96 so as to create the friction and interference needed to minimize unwanted or unintentional removal of the drawer 16 from the main body 12. As such, upon a user applying a force to the drawer 16 and pulling the drawer 16 from the main body 12, the drawer 16 may be removed from the interior 26 such that the undulation 148 and ridges 150 may slide past one another.

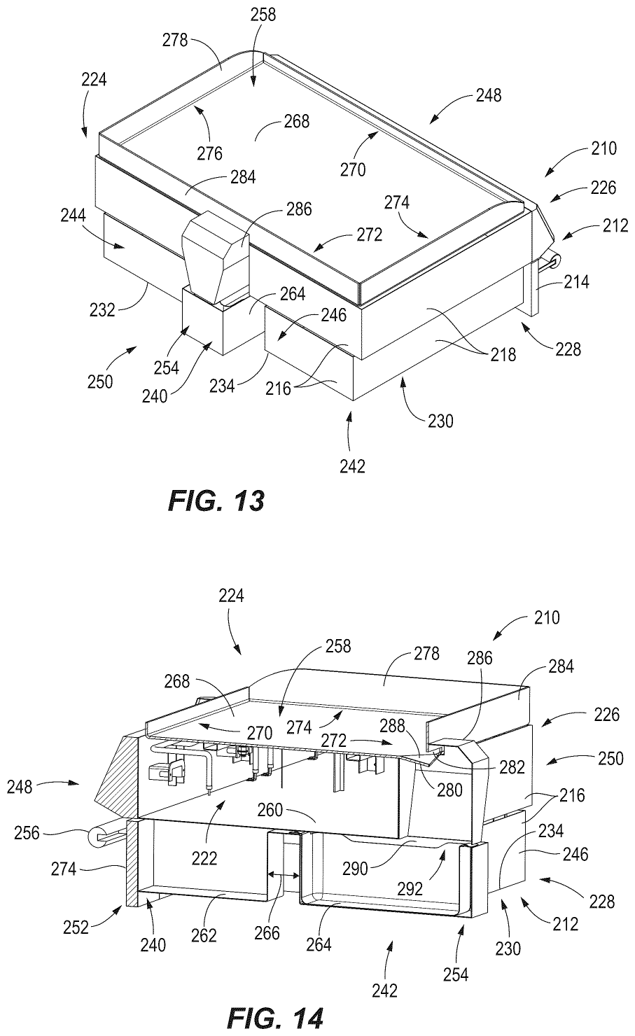

With reference to FIGS. 11-14, another embodiment of the cooking system 210 with similar components of the previous embodiment is provided. For example, portions of the drawings of this embodiment may not depict all the components, such as the heating element, burner knobs, and control panel, but such components may readily be implemented to this embodiment, similar to that provided in the previous embodiment, as known to one of ordinary skill in the art. This embodiment of the cooking system 210 depicts another version, similar to the previous embodiment, for managing grease generated by cooking on a griddle 258, the griddle defining an opening 282 therein that facilitates draining grease from the opening 282 and into a drawer such that the drawer may be removed from a front side of the cooking system 210 or cooking station.

In this embodiment, the cooking system 210 may include a main body 212 extending to define a front panel 214, a rear panel 216, a left panel 218, and a right panel 220 to define an interior 222 and an exterior 224 of the main body 212. The front, rear, left, and right panels 214, 216, 218, 220 may extend to define an upper periphery 226 and a lower periphery 228 of the main body 212. The lower periphery 228 of the main body 212 may include a bottom panel 230 positioned to be coupled to the front, rear, left, and right panels 214, 216, 218, 220. In this embodiment, the bottom panel 230 may include a right bottom panel 232 and a left bottom panel 234. The right bottom panel 232 may extend to couple to the front panel 214, the rear panel 216, and the right panel 220. The left bottom panel 234 may extend to couple to the front panel 214, the rear panel 216, and the left panel 218. Even further, the right bottom panel 232 and the left bottom panel 234 may extend towards a right center panel 236 and a left center panel 238 extending adjacent and parallel to one another with the drawer 240 positioned therebetween. The right center panel 236 and left center panel 238 may enclose the interior 222 from a lower side 242 of the main body 212 so as to define a right lower portion 244 and a left lower portion 246. The right lower portion 244 and the left lower portion 246 may be sized and configured for the drawer 240 to be positioned therebetween.

The drawer 240 may be configured to retain grease and food debris or byproduct and may extend from a front side 248 of the main body 212 to a rear side 250 of the main body 212 so as to define a front end 252 and a rear end 254 of the drawer 240. The front end 252 of the drawer 240 may be positioned along the front panel 214 and the rear end 254 may be positioned along the rear panel 216 of the main body 212. The front end 252 may include a hand hold 256 configured to be pulled in a direction, as shown by arrow 257, that may extend parallel to a cooking surface of the griddle 258. The griddle 258 may be positioned on an upper periphery 226 of the main body 212. In other embodiments, the rear end 254 of the drawer 240 may extend rearward or beyond the rear panel 216 of the main body 212. As stated in the previous embodiment, the drawer 240 may extend within the interior 222 of the main body 212. In another embodiment, the drawer 240 may extend along the exterior 224 of the main body 212 where a panel 260 may extend between the interior 222 of the main body 212 and the drawer 240 such that the drawer 240 may be closed off from the interior 222 of the main body 212. The drawer 240 may extend to include a front container 262 and a rear container 264 with a gap 266 extending therebetween. The front container 262 may be positioned adjacent the front end 252 of the drawer 240 and the rear container 264 may be positioned adjacent the rear end 254 of the drawer 240. The gap 266, extending between the front container 262 and rear container 264, may separate the front end 252 from the rear end 254 of the drawer 240. In one embodiment, the front container 262 of the drawer 240 may be configured to hold items for outdoor cooking such as spices or any other desired items while the rear container 264 of the drawer 240 may be configured to capture and contain grease and food debris drained off of a cooking surface 268 or upper surface of the griddle 258 to the rear container 264. Further, the rear container 264 may be sized to receive a disposable container (not shown) to be positioned within the rear container 264 to assist the user in discarding food byproduct from the rear container 264.

The upper periphery 226 may be sized and configured to support the griddle 258 thereon. In another embodiment, the griddle 258 may be set in the interior 222 of the main body 212 adjacent to the upper periphery 226, similar to the previous embodiment. The cooking surface of the griddle 258 may extend to a front periphery 270, a rear periphery 272, a left periphery 274, and a right periphery 276. Further, the griddle 258 may also include a splash guard 278 coupled to the cooking surface 268 of the griddle 258 and extending along each of the front, rear, left, and right periphery 270, 272, 274, 276 of the griddle 258. In one embodiment, the cooking surface 268 of the griddle 258 may include a grease trough 280 positioned adjacent the rear periphery 272 of the griddle 258 such that the opening 282 may be defined partially by or in a rear splash guard 284 and the rear periphery 272 of the griddle 258. The grease trough 280 may be configured to direct grease from the cooking surface 268 of the griddle 258 through the opening 282 to the drawer 240 positioned adjacent and below the cooking surface 268 of the griddle 258.

The main body 212 may include a conduit 286 positioned adjacent the rear side 250 of the main body 212 and adjacent the grease trough 280. The conduit 286 may be coupled to the rear panel 216 adjacent to the upper periphery 226 of the rear panel 216 of the main body 212. In another embodiment, the conduit 286 may extend over the grease trough 280 to be coupled to the rear splash guard 284 of the griddle 258. The rear panel 216 may extend between the conduit 286 and the interior 222 of the main body 212 so as to enclose the conduit 286. In another embodiment, the grease trough 280, being positioned adjacently along the rear periphery 272 and rear splash guard 284 of the griddle 258, may exhibit a slope 288 so as to extend at an acute angle relative to the cooking surface 268 so as to extend downwards adjacent the opening 282 and toward the conduit 286. With this arrangement, grease and food debris may readily flow along the slope 288, through the conduit 286, and into the drawer 240. In another embodiment, the conduit 286 may include a floor 290 extending from within the interior 222 of the main body 212 to the conduit 286 such that the floor 290 may extend between the drawer 240 and the conduit 286. The floor 290 may define a hole 292 positioned substantially below the grease trough 280 and above the drawer 240, such that grease and food debris may be directed off the cooking surface 268 of the griddle 258 along the slope 288 and through the hole 292 and into the rear container 264 of the drawer 240. In one embodiment, the conduit 286 may be coupled to the rear panel 216 of the main body 212 and rear splash guard 284 of the griddle 258. In another embodiment, the conduit 286 may be configured to be detached from the main body 212 such that the conduit 286 and grease trough 280 may be cleaned. The drawer 240 may be removable from the front side 248 of the main body 212 such that the rear container 264 of the drawer 240 may be removed from the main body 212 and cleaned.

The embodiments set forth herein of a cooking station and griddle and the components thereof may be formed of metallic materials and some polymeric materials. For example, the various components of the cooking station may be formed of various metallic materials, such as steel, stainless steel, aluminum, copper or any other suitable metallic material or the like, formed with paneling, and various stock material to form various frame components, such as extensions, cross-members, tubular structures or any other suitable components, that may be coupled together with typical fasteners and/or bolts, or by welding, as known by one of ordinary skill in the art. Some components of the cooking station may be formed from various polymeric materials that can withstand high temperatures, as known in the art. Further, the various components of the cooking station may be formed by employing known manufacturing techniques and processes, such as welding, molding, milling, drilling, bending, fastening, soldering, etc., as known to one of ordinary skill in the art.

The griddle may also be formed from metallic materials, such as, carbon steel, cast iron, stainless steel, or aluminum, or various metal alloys, or any other suitable cooking surface material known in the art, such as porcelain coated materials. The metallic materials may be manufactured using cold rolled steel processes, or hot rolled steel techniques, or any other known manufacturing process, such as casting or stamping, as known in the art. The various plate components of the griddle may include a thickness of 5-6 millimeters, but is not so limited, as such thickness of the various components of the griddle may range, for example, between 3-10 millimeters. Further, the understructure of the griddle may be formed from similar metallic materials as the griddle and formed with typical metal cutting techniques and processes and coupled to the underside surface of the griddle with known techniques, such as welding. Also, portions of the griddle, such as the understructure and splash guard may be formed by employing cutting and bending techniques from plate material to form the griddle as well as forming such portions of the griddle by employing welding techniques, or employing any other known process or techniques to form the griddle, as known by one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A cooking system configured to manage food byproduct generated from cooking with the cooking system, comprising:
a main body extending to define a front side, a rear side, a left side, and a right side, the main body including a heating element positioned within an interior thereof, the front side, the rear side, the left side, and the right side extending to an upper periphery and lower periphery of the main body;
a griddle positioned adjacent to the upper periphery such that the griddle extends over the interior of the main body so that the heating element is positioned along an underside of the griddle, the griddle including a flat cooking surface and a splash guard extending upward from the flat cooking surface, the flat cooking surface extending to define a front end, a rear end, a left end and a right end such that the front end extends generally parallel with the rear end and the left end extends generally parallel with the right end, the griddle including an opening defined adjacent the rear end of the griddle; and
a drawer including a bottom wall and an upright wall extending between a front end portion and a rear end portion of the drawer, the drawer configured to hold a removable grease container positioned on the bottom wall of the drawer, the drawer configured to be removably positioned at least partially within the interior of the main body such that the grease container is positioned adjacent the rear side of the main body and below the opening defined in the griddle with the front end of the drawer positioned along the front side of the main body so that the drawer is moveable from the front side of the main body.

2. The cooking system of claim 1, wherein the grease container is moveable within the drawer between a rear position and a forward position.

3. The cooking system of claim 2, wherein, upon the grease container being in the forward position, the grease container is removable from the drawer.

4. The cooking system of claim 2, wherein, upon the grease container being in the rear position, the grease container is prevented from being removed from the drawer with a top flange extending inward from the upright wall of the drawer.

5. The cooking system of claim 1, wherein the heating element is an electrical heating element, the electrical heating element extending through an understructure of the griddle.

6. The cooking system of claim 1, wherein the main body comprises a heat shield, the heat shield extending between the heating element and the drawer, the heat shield configured to shield the grease container from heat of the heating element.

7. The cooking system of claim 1, wherein the main body comprises a bottom panel such that the drawer is configured to be moveably positioned above the bottom panel, the drawer including ridges along the bottom wall of the drawer, and the bottom panel including undulations defined therein, the undulations in the bottom panel configured to correspond with the ridges of the drawer to assist in preventing the drawer from being unintentionally removed from the main body.

8. The cooking system of claim 1, wherein the opening is defined at least partially by the splash guard of the griddle.

9. The cooking system of claim 1, wherein the opening is defined in the cooking surface of the griddle.

10. The cooking system of claim 1, wherein the griddle is coupled to a conduit, the conduit extending from the griddle toward the grease container to funnel grease from the opening of the griddle.

11. A cooking station configured to manage food byproduct generated from cooking with the cooking station, comprising:
a main body extending to define a front panel, a rear panel, a left panel, and a right panel, the main body including an electrical heating element positioned within an interior thereof, the front panel, the rear panel, the left panel, and the right panel extending to an upper periphery and lower periphery of the main body;
a griddle positioned adjacent to the upper periphery such that the griddle extends over the interior of the main body so that the electrical heating element is positioned along an underside of the griddle, the griddle including a flat cooking surface and a splash guard extending upward from the flat cooking surface, the flat cooking surface extending to define an opening adjacent a rear end of the flat cooking surface of the griddle; and
a drawer extending between a front end portion and a rear end portion of the drawer, the drawer configured to hold a removable grease container positioned adjacent the rear end portion of the drawer, the drawer configured to be removably positioned at least partially within the interior of the main body such that the grease container is positioned adjacent the rear panel of the main body and below the opening defined in the griddle with the front end of the drawer positioned along the front panel of the main body so that the drawer is moveable from the front panel of the main body.

12. The cooking station of claim 11, wherein the grease container is moveable within the drawer between a rear position and a forward position.

13. The cooking station of claim 12, wherein, upon the grease container being in the forward position, the grease container is removable from the drawer.

14. The cooking station of claim 12, wherein, upon the grease container being in the rear position, the grease container is prevented from being removed from the drawer with a top flange extending inward from an upright wall of the drawer.

15. The cooking station of claim 11, wherein the main body comprises a heat shield, the heat shield extending between the heating element and the drawer, the heat shield configured to shield the grease container from heat of the heating element.

16. The cooking station of claim 11, wherein the main body comprises a bottom panel such that the drawer is configured to be moveably positioned above the bottom panel, the drawer including ridges along the bottom wall of the drawer, and the bottom panel including undulations defined therein, the undulations in the bottom panel configured to correspond with the ridges of the drawer to assist in preventing the drawer from being unintentionally removed from the main body.

17. The cooking station of claim 11, wherein the griddle is coupled to a conduit, the conduit extending from the griddle toward the grease container to funnel grease from the opening of the griddle.

18. A method for managing food byproduct while cooking on a cooking station, the method including:
providing a main body including a front panel, rear panel, left panel, and right panel extending to define an interior, the main body configured to support a heating element positioned within the interior of the main body, the main body configured to support a griddle positioned adjacent an upper periphery of the main body such that the griddle extends over the interior of the main body, the griddle having a flat cooking surface and the griddle defining an opening therein such that the opening is positioned adjacent a rear periphery of the flat cooking surface of the griddle;
pushing the food byproduct to the opening of the griddle such that the food byproduct drains through a conduit to facilitate draining the food byproduct to a grease container of a drawer positioned within the interior of the main body, the drawer extending between a front end and a rear end such that the grease container is removably positionable adjacent the rear end of the drawer; and
removing the drawer from the interior of the main body by grasping the front end of the drawer positioned adjacent the front panel of the main body so that the grease container of the drawer slides from adjacent the rear panel of the main body and out of the main body to discard the food byproduct from the grease container.

19. The method according to claim 18, wherein the removing the drawer comprises sliding the grease container within the drawer between a rear position in the drawer and a forward position within the drawer.

20. The method according to claim 19, wherein the sliding comprises removing the grease container from the drawer upon the grease container being in the forward position.

21. The method according to claim 19, wherein the sliding comprises preventing removal of the grease container, upon the grease container being in the rear position, due to the drawer having a top flange extending inward from an upright wall of the drawer.

22. The method according to claim 18, further comprising shielding the grease container in the drawer from heat of the heating element with a heat shield positioned between the heating element and the drawer.

23. The method according to claim 18, further comprising heating the griddle with an electrical heating element such that the electrical heating element extends through an understructure of the griddle.
